(19) United States
(12) Patent Application Publication
(10) Pub. No.: US 2016/0101553 A1
(43) Pub. Date: Apr. 14, 2016

(54) PROCESSES FOR CLEANING MELT PROCESSING EQUIPMENT

(71) Applicant: TICONA LLC, FLORENCE, KY (US)

(72) Inventors: Richard MOORE, Union, KY (US); Cole FOOR, Newport, KY (US)

(21) Appl. No.: 14/880,430

(22) Filed: Oct. 12, 2015

Related U.S. Application Data
(60) Provisional application No. 62/062,282, filed on Oct. 10, 2014.

(51) Int. Cl. B29C 47/08

(52) U.S. Cl. CPC B29C 47/0881; B29K 2023/06; B29K 2105/16

(57) ABSTRACT

A process for cleaning melt processing equipment used to compound, mold and/or extrude a polymeric resin includes supplying to the melt processing equipment a particulate purge material comprising polyethylene having a viscosity number from 300 to 3,500 ml/g and an average particle size, d50, from 50 to 1000 micron, heating the melt processing equipment to a temperature sufficient to allow the purge material to be extruded through the equipment, and running the equipment to extrude the purge material while cleaning the melt processing equipment.

### CROSS REFERENCE TO RELATED APPLICATIONS

This application claims the benefit of the filing date of U.S. Provisional Application No. 62/062,282 filed Oct. 10, 2014, the entire contents of which are incorporated herein by reference.

### FIELD

The present invention relates to processes for cleaning melt processing equipment used to compound, mold and/or extrude resin compositions.

### BACKGROUND

Extruders using a melt conveying screw accomplish a large portion of the melt processing of thermoplastic resins. The extruder can be used for compounding, molding, pelletization or forming films, sheets or profiles. Such extruders typically have a heated extrusion barrel and one or two screws revolving within the barrel to compress, melt, and extrude the resin through an orifice in an extrusion nozzle. The barrel is divided into several different zones, such as feed, transition, mixing, dispersion, and metering zones. When such machines are dedicated to making a single material in a single color, they can be very efficient. However, when the same machine is used to make a variety of materials and/or colors, there is a need to changeover or switch between materials (i.e. changeover process). Otherwise, impurities or residues created during the extrusion of the first, preceding resin can contaminate the second, succeeding resin. During this changeover process, the extruder produces a combination of the preceding material/color and the succeeding material/color. As a result, the combination may not meet desired specifications, e.g. compositional differences, a loss of clarity, a change in color or viscosity, or some other defect. In addition, the changeover process leads to a loss of material and a decrease in manufacturing efficiency.

In the past this problem has been addressed in a number of ways. For example, at the time of such color exchange or resin exchange, in order to remove contaminants caused by the preceding resin inside the extruder, it is known to remove the contaminated screw from the extruder and then manually wire brush the screw and the inner walls of the cylinder to clean them. However, this process is extremely time and operator intensive and so significantly adds to the cost of the overall extrusion process.

A more effective method is to use a purging compound. These materials usually comprise pellets of at least polymeric material formulated with a variety of additives to provide more thorough cleaning and/or to enhance the flame retardant properties of the base polymeric material. However, these pelletized purge materials have to be added very slowly to the extruder to achieve effective softening/melting of the polymeric material and typically require high torque to force the purge material through the extruder. In addition, different purge materials are frequently required to purge resins extruded at high temperatures (greater than 260° C.), such as liquid crystal polymers and polyarylene sulfides, than resins extruded at lower temperatures (less than 260° C.), such as polyoxymethylene polymers, polyesters, such as polybutyl terephthalate and polyolefins.

There is therefore a continued need for improved polymer purge compositions and processes.

### SUMMARY

According to one aspect of the invention, there is provided is a process for cleaning melt processing equipment used to compound, mold and/or extrude a polymeric resin, comprising supplying to the melt processing equipment a particulate purge material comprising at least 75 wt % of polyethylene having a viscosity number from 300 to 3,500 ml/g and an average particle size, d50, from 50 to 1000 micron, heating the melt processing equipment to a temperature sufficient to allow the purge material to be extruded through the equipment, and running the equipment to extrude the purge material while cleaning the melt processing equipment.

In one embodiment, the particulate purge material comprises in excess of 95 wt % of said polyethylene, and/or the particulate purge material consists essentially of said polyethylene.

According to a further aspect of the invention, there is provided is a process for cleaning melt processing equipment used to compound, mold and/or extrude a polymeric resin, comprising supplying to the melt processing equipment a particulate purge material comprising at least 5 wt % of polyethylene having a viscosity number from 300 to 3,500 ml/g and an average particle size, d50, from 50 to 1000 micron and up to 95 wt % of at least one extrudable, thermoplastic further polymeric material, heating the melt processing equipment to a temperature sufficient to allow the purge material to be extruded through the equipment, and running the equipment to extrude the purge material while cleaning the melt processing equipment.

In one embodiment, the polyethylene has an HLMI from 0.05 to 3 g/10 minutes, and/or an average particle size, d50, from 100 to 800 micron.

It can be advantageous if the polyethylene has a specific surface area of from 0.05 to 4.0 m²/g.

In one form, the polymeric resin is selected from the group consisting of polyolefins, polyesters, polyoxymethylene, polycarbonate, acrylonitrile/butylene/styrene, nylon, polyurethane and poly(cyclohexanedimethanol terephthalate) polymers, and the melt processing equipment is heated to a temperature from 100° C. to 260° C.

In another form, the polymeric resin is selected from the group consisting of liquid crystal polymers, polyarylene sulfides, polyether ether ketones, and polyether ketone ketones, and the melt processing equipment is heated to a temperature from 260° C. to 410° C.

### DETAILED DESCRIPTION

Various aspects will now be described with reference to specific forms selected for purposes of illustration. It will be appreciated that the spirit and scope of the apparatus, system and methods disclosed herein are not limited to the selected forms.

Each of the following terms written in singular grammatical form: “a,” “an,” and “the,” as used herein, may also refer to, and encompass, a plurality of the stated entity or object, unless otherwise specifically defined or stated herein, or, unless the context clearly dictates otherwise. For example, the phrases “a device,” “an assembly,” “a mechanism,” “a component,” and “an element,” as used herein, may also refer to, and encompass, a plurality of devices, a plurality of assemblies, a plurality of mechanisms, a plurality of components, and a plurality of elements, respectively.

It is to be understood that all technical and scientific words, terms, and/or phrases, used herein throughout the present disclosure have either the identical or similar meaning as commonly understood by one of ordinary skill in the art, unless otherwise specifically defined or stated herein. Phraseology, terminology, and, notation, employed herein throughout the present disclosure are for the purpose of description and should not be regarded as limiting.

According to the present invention, a process is provided for cleaning melt processing equipment used to compound, mold and/or extrude a polymeric resin, comprising supplying to the melt processing equipment a particulate purge material comprising polyethylene having a viscosity number from 300 to 3,500 ml/g and an average particle size, d50, from 50 to 1000 micron, heating the melt processing equipment to a temperature sufficient to allow the purge material to be extruded through the equipment, and running the equipment to extrude the purge material while cleaning the melt processing equipment. After cleaning, the melt processing equipment can be used to compound, mold and/or extrude the same or different polymeric resin, for example a resin composition having a different color.

Viscosity numbers used herein are determined according to ISO 1628, part 3 using a solution of the polyethylene in decahydronaphthalene at a concentration of 0.0002 to 0.001 g/ml. In some embodiments, the viscosity number of the polyethylene purge material used in the present process is from 400 to 3,000 ml/g, such as from 500 to 2,000 ml/g, for example from 500 to 1,500 ml/g.

In some embodiments, the particulate polyethylene purge material used herein has an HLMI from 0.05 to 3 g/10 minutes, for example from 0.5 to 2 g/10 minutes. The term “HLMI” means high load melt index, which is defined by ASTM D1238, condition F, in which the melt flow rate of polyethylene is measured at a temperature of 190° C. at a load of 21.6 kg.

The viscosity and melt index of a polymer are known in the art to be indicative of its molecular weight. In some embodiments, the polyethylene purge material has an average molecular weight as calculated by the Margolies' equation from 300,000 to 8,000,000 g/mol, such as from 400,000 to 4,000,000 g/mol, for example from 500,000 to 3,000,000 g/mol.

The polyethylene used according to the present process has an average particle size, d50, from 50 to 1000 micron, such as from 75 to 800 micron. The particles can be in the form of flakes or powder. In some embodiments, the d50 of the polyethylene flake/powder of the present process can be relatively high, for example from 500 to 1000 micron, such as from 500 to 800 micron, as compared to that often specified for sale. For example, the polyethylene flake/powder useful according to the present process can be the “overs” obtained from commercial polymerization processes. That is, when commercially produced polyethylenes are sieved to particle sizes meeting typical specifications, the larger, oversized particles (the “overs”) are removed and used in formulating the particulate purge material of the present invention. Use of particulate overs avoids having to discard, recycle or otherwise dispose of these oversized particles. Larger particle size polyethylene useful in the present process can also be produced by direct synthesis. In other embodiments, the polyethylene purge material used in the present process employs smaller particles, namely with a d50 from 50 to less than 500 micron, such as from 100 micron to 300 micron, for example from 125 micron to 200 micron. All the polyethylene powder particle size measurements referred to herein are obtained by a laser diffraction method according to ISO 13320.

It can be advantageous if the polyethylene purge material has a specific surface area ratio (surface area per unit mass as determined by BET methods) of from 0.05 to 4.0 m²/g, such as from 0.1 to 3.5 m²/g, for example from 0.5 to 3 m²/g.

In some embodiments, the bulk density of the particulate polyethylene purge material used in the present process may be from 0.30 g/cm³ to 0.55 g/cm³, such as from 0.35 g/cm³ to 0.5 g/cm³, for example from 0.38 g/cm³ to 45 g/cm³. Bulk density measurements referred to herein are measured according to ISO 60.

In some embodiments, the polyethylene purge material of the present invention is employed in the form of individual particles without formation into pellets. In addition, the present purge material may be uncompounded, in that it does not include major amounts of additives which are common in conventional purge materials. In some embodiments, the particulate purge material comprises at least about 75 wt % of polyethylene having a viscosity number from 300 to 3,500 and an average particle size, d50, from 50 to 1000 micron, such as at least 80 wt % of said polyethylene, for example at least 85 wt % of said polyethylene, such as at least 90 wt % of said polyethylene, or even at least 95 wt % of said polyethylene. In some embodiments, the particulate purge material may consist essentially of said polyethylene. However, in other embodiments, minor amounts of conventional additives, such as up to about 25 wt % can be added to the present purge material. Conventional additives can include lubricants, abrasives (such as glass fibers), fillers, flame retardants or the like, but the preference is that the purge material is uncompounded and that such additives are absent. Generally, such additives are present in an amount less than 5 wt %.

In other embodiments, the polyethylene purge material described above (having a viscosity number from 300 to 3,500 ml/g and an average particle size, d50, from 50 to 1000 micron) may be blended with one or more extrudable, thermoplastic further polymeric materials conventionally used as purge media. Useful blends of the polyethylene purge material and the further polymeric material can comprise at least 5 wt %, or at least 10 wt %, or at least 25 wt %, or at least 50 wt %, or at least 75 wt % of the polyethylene purge material and up to 95 wt %, or up to 90 wt %, or up to 75 wt %, or up to 50 wt %, or up to 25 wt % of the further polymeric material. Illustrative, but non-limiting, examples of such further polymeric materials include polypropylene, polyoxymethylene, a polycarbonate and a polyester (for example polybutyl terephthalate and nylon). For example, in some cases, especially when the purge material is used to clean melt processing equipment where torque levels are limited, it may be desirable to blend the polyethylene purge material with a further polymeric material having a higher melt index (measured at a temperature of 190° C. at a load of 2.16 kg according to ASTM D1238, condition E) than the polyethylene purge material, for example having an MI greater than 1. Such blends may also contain minor amounts of conventional additives, including lubricants, abrasives (such as glass fibers), fillers, flame retardants or the like.

When the particulate purge material of the present invention is appropriately selected, the viscosity of the material is sufficient at melt processing equipment purging temperatures and pressures to significantly improve the cleaning time of the critical compounding equipment, including but not limited to, screw, die, die plates, barrel. As with conventional pelletized purge materials, the particulate polyethylene purge used in the present process still requires removal of the screw and cleaning of the barrel, die tooling and screw prior to changing over to a new resin. However, the present purge material reduces the time to clean the extrusion equipment. For instance barrel cleaning time may be reduced from 2 hours to 30 minutes for difficult resins and 45 minutes to 15 minutes for easy to clean resins.

In addition, by varying the purge temperature, the same particulate polyethylene described herein can be used to clean extrusion equipment used to process both low and high melt processing temperature polymeric resins. For example, when relatively low melt processing temperature polymeric resins, such as polyolefins, polyesters, polyoxymethylene, polycarbonate, acrylonitrile/butylene/styrene (ABS), nylon, polyurethane and poly(cyclohexanedimethanol terephthalate) (PCT) polymers, purging may be effected at a temperature from about 100° C. to about 310° C., such as from about 100° C. to about 260° C. Alternatively, when the polymeric resin is one which requires relatively high melt processing temperatures, such as liquid crystal polymers, polyarylene sulfides, polyether ether ketones (PEEK), and polyether ketone ketones (PEKK), purging may be effected at a temperature from 260° C. to 410° C., such as from about 260° C. to about 375° C. Even at purge temperatures of at least 353° C., good purging of the melt processing equipment can be achieved without flame generation in the absence of any flame retardant additives.

Surprisingly, the particulate purge material according to the invention allows a higher level of feed in the rotating portions of the melt processing equipment with lower torque than conventional pelletized purge materials, which reduces the possibility of premature wear and even failure. In addition, using the particulate polyethylene described herein, the amount of purge material required to achieve the same degree of cleaning is reduced as compared with conventional purge materials.

### EXAMPLES

### Comparative Example 1

Polyoxymethylene composition was extruded through a 40 mm twin screw extruder at a temperature of 200° C. to form extruded product. Subsequently, a purging material consisting of 4 to 6 mm pellets consisting of Schulman LP477-01 high density polyethylene with a MI of 0.3 g/10 min by condition E ASTM D1238 was passed through the extruder at a temperature from 200° C. to 250° C. for about 10 minutes. The torque created during purging was measured, and the extruder was disassembled to assess the quality of the purge.

### Example 1

The process of Comparative Example 1 was repeated, except that particles consisting of polyethylene having a viscosity number of 600 ml/g, a HLMI of about 1.3 g/10 min, and a d50 particle size of about 600 micron were used as the purging material. Purging was effected at a temperature generated of about 180-250° C. The torque created during purging was measured and was equal to or less than that in Comparative Example 1. The extruder was disassembled to assess the quality of the purge and the extruder components were observed to be cleaner from built-up resin and color, and the remaining resin build-up was easier to remove as compared to that in Comparative Example 1. The time and amount of purge material required to complete purging was reduced to about ½ that of Comparative Example 1.

### Comparative Example 2

Polyphenylene sulfide was extruded through a 40 mm twin screw extruder at a temperature of 330° C. to form extruded product. Subsequently, a purging material consisting of a 4 to 6 mm pellets of Purgex 458 Plus (67.5 wt % HDPE, 2.5 wt % Purgex™ 527 and 30% PE [30% glass filled]) was passed through the extruder at a temperature from 330° C. to 350° C. for about 15 minutes. The torque created during purging was measured, and the extruder was disassembled to assess the quality of the purge.

### Example 2

The process of Comparative Example 2 was repeated, except that particles consisting of polyethylene having a viscosity number of 600 ml/g, a HLMI of about 1.3 g/10 min, and a d50 particle size of about 600 micron were used as the purging material. Purging was effected at a temperature of about 300-350° C. The torque created during purging was measured and was equal to or less than that in Comparative Example 2. The extruder was disassembled to assess the quality of the purge and the extruder components were observed to be cleaner from built-up resin and color, and the remaining resin build-up was easier to remove as compared to that in Comparative Example 2. The time and amount of purge material required to complete purging was reduced to about ¾ of that of Comparative Example 2.

### Example 3

A series of experiments were conducted to investigate the effect both on purge rates and cleaning performance of blending the polyethylene used in Examples 1 and 2 (with a viscosity number of 600 ml/g, a HLMI of about 1.3 g/10 min, and a d50 particle size of about 600 micron) with varying amounts of a conventional polypropylene purge material, in this case Hostalen PP W 2080 (having a melt flow rate of 50g/10 min at 230° C. and a load of 2.16 kg). Three blends of with increasing content of polyethylene, as well as a reference material containing 100% of Hostalen PP W 2080, were tested using a Berstorff 25 mm twin screw extruder equipped with a high sheer screw (S-screw).

In an initial set of tests, the maximum feeding speed of the different materials to obtain 80% of the maximum torque of the extruder was determined The results are shown in Table 1.

TABLE 1

| | Maximum |
|---|---|
| | throughput for 80% max- |
| Material | torque in kg/h |
| Reference Material Hostalen PP W2080 | 11.4 |
| Example 1 PE + W2080 (10:90 wt %) | 11.0 |
| Example 1 PE + W2080 (25:75 wt %) | 9.5 |
| Example 1 PE + W2080 (50:50 wt %) | 5.2 |

As expected, the maximum feed rate decreased as the concentration of high melt viscosity polyethylene increased.

In a second set of tests, the cleaning performance of the different blends was compared. In order to create a reproducible contamination of the extruder, a black polyoxymethylene formulation was extruded for 30 minutes at 4.8 kg/h, 190° C. and 100 rpm before each purge. Leaving the head and plate on, the extruder was run dry. Using the pre-determined maximum feed rates from Table 1, the purge was performed at 190° C. and 100 rpm until the extruded strand became completely white. The purge time and the material required for the purge were determined Samples were taken every three minutes and the results are shown in Table 2. After the purge, the screw was filled with a high MR polyoxymethylene to make a screwpull possible (since no screwpuller is available, this is the usual procedure also for purging with reference material). The cleanliness of the screws was evaluated visually. Additionally, the time required for sandblasting was recorded. For the cleanliness of the barrel, the amount of cleaning cycles with a cloth were counted until no more black contamination was rubbed off.

TABLE 2

| | | Time until strand | |
|---|---|---|---|
| | Throughput | was white in | Material used |
| Material | in kg/h | minutes | for purge in kg |
| Reference Material | 11.4 | 12 | 2.3 |
| Hostalen PP W2080 | | | |
| Example 1 PE + | 11.0 | 12 | 2.2 |
| W2080 (10:90 wt %) | | | |
| Example 1 PE + | 9.5 | 12 | 1.9 |
| W2080 (25:75 wt %) | | | |
| Example 1 PE + | 5.2 | 12 | 1.1 |
| W2080 (50:50 wt %) | | | |

Within the accuracy of the experiment, all purges required the same amount of time until the strand was colorless. Due to the lower throughput, the PE-containing blends required a lower amount of purge material. The trend clearly shows, that the higher the PE fraction was, the lower the amount of material required for a full purge.

In order to exclude the difference in throughput as reason for the increased purge efficiency, an additional experiment with the reference material was performed using a lower throughput (5.2 kg/h). In this case, the purge time was longer (21 minutes) compared to the PE-containing blends.

Concerning cleanliness of screw and barrel, no difference between the purges could be determined In all cases, some black pigment remained in the feeding zone of the screw, making an additional sandblast necessary.

The results clearly show that the increased effectiveness of high melt viscosity polyethylene as a purge material is also seen in a blend with a lower melt viscosity purge material.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A process for cleaning melt processing equipment used to compound, mold and/or extrude a polymeric resin, comprising: supplying to the melt processing equipment a particulate purge material comprising at least 75 wt % of polyethylene having a viscosity number from 300 to 3,500 ml/g and an average particle size, d50, from 50 to 1000 micron, heating the melt processing equipment to a temperature sufficient to allow the purge material to be extruded through the equipment, and running the equipment to extrude the purge material while cleaning the melt processing equipment.

2. The process according to claim 1, wherein the polyethylene has a viscosity number from 400 to 3,000 ml/g.

3. The process according to claim 1, wherein the polyethylene has a viscosity number from 500 to 2,000 ml/g.

4. The process according to claim 1, wherein the polyethylene has a viscosity number from 500 to 1,500 ml/g.

5. The process according to claim 1, wherein the polyethylene has an HLMI from 0.05 to 3 g/10 minutes.

6. The process according to claim 1, wherein the polyethylene has an HLMI from 0.5 to 2 g/10 minutes.

7. The process according claim 1, wherein the polyethylene has an average particle size, d50, from 75 to 800 micron.

8. The process according to claim 1, wherein the particulate purge material has a specific surface area ratio from 0.05 to 4.0 m²/g.

9. The process according to claim 1, wherein the particulate purge material has a bulk density from 0.30 g/cm³ to 0.55 g/cm³.

10. The process according to claim 1, wherein the particulate purge material comprises at least 95 wt % of said polyethylene.

11. The process according to claim 1, wherein the particulate purge material is uncompounded and consists essentially of said polyethylene.

12. The process according to claim 1, wherein the polymeric resin is selected from the group consisting of polyolefins, polyesters, polyoxymethylene, polycarbonate, acrylonitrile/butylenes/styrene, nylon, polyurethane and poly(cyclohexanedimethanol terephthalate) polymers, and the melt processing equipment is heated to a temperature from 100° C. to 260° C.

13. The process according to claim 1, wherein the polymeric resin is selected from the group consisting of liquid crystal polymers, polyarylene sulfides, polyether ether ketones, and polyether ketone ketones and the melt processing equipment is heated to a temperature from 260° C. to 410° C.

14. A process for cleaning melt processing equipment used to compound, mold and/or extrude a polymeric resin, comprising supplying to the melt processing equipment a particulate purge material comprising at least 5 wt % of polyethylene having a viscosity number from 300 to 3,500 ml/g and an average particle size, d50, from 50 to 1000 micron and up to 95 wt % of at least one extrudable, thermoplastic further polymeric material, heating the melt processing equipment to a temperature sufficient to allow the purge material to be extruded through the equipment, and running the equipment to extrude the purge material while cleaning the melt processing equipment.

15. The process of claim 14, wherein the particulate purge material comprises at least 25 wt % of said polyethylene.

16. The process of claim 14, wherein the particulate purge material comprises at least 50 wt % of said polyethylene.

17. The process of claim 14, wherein the further polymeric material comprises at least one of polypropylene, polyoxymethylene, a polycarbonate and a polyester.

18. The process according to claim 14, wherein the polyethylene has a viscosity number from 500 to 2,000 ml/g.

19. The process according to claim 14, wherein the polyethylene has a viscosity number from 500 to 1,500 ml/g.

20. The process according to claim 14, wherein the polyethylene has an HLMI from 0.05 to 3 g/10 minutes.
